(19) United States
(12) Patent Application Publication
(10) Pub. No.: US 2007/0002718 A1
(43) Pub. Date: Jan. 4, 2007

(54) OPTICAL HEAD DEVICE AND METHOD OF MANUFACTURING OPTICAL HEAD DEVICE

(75) Inventors: Shinroku Asakawa, Nagano (JP); Yuichi Takei, Nagano (JP)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(73) Assignee: NIDEC Sankyo Corporation

(21) Appl. No.: 11/427,239

(22) Filed: Jun. 28, 2006

(30) Foreign Application Priority Data
Jun. 29, 2005 (JP) 2005-190023
Jun. 29, 2005 (JP) 2005-190193

(51) Int. Cl. G11B 7/00

(52) U.S. Cl. 369/120; 369/44.12; 369/122

(57) ABSTRACT

An optical head device comprises a frame-type laser photo emitter having a semiconductor laser chip mounted on a lead frame. The frame is molded of resin and opens on a side where the chip is mounted. The frame-type laser photo emitter is mounted onto a base together with optical components. A photo emitter holder is provided for mounting the photo emitter on the base. The photo emitter holder has mounting portions for mounting the laser photo emitter and a notch that is cut out in a direction orthogonal to an optical axis of light emitted by the semiconductor laser chip for mounting the laser photo emitter onto the mounting portions. The laser photo emitter is fixed to the notch by an adhesive.

### CROSS-REFERENCE TO RELATED APPLICATIONS

This application claims priority of Japanese Application No. 2005-190023, filed Jun. 29, 2005 and Japanese Application No. 2005-190193, filed Jun. 29, 2005, the complete disclosures of which are hereby incorporated by reference.

### BACKGROUND OF THE INVENTION

a) Field of the Invention

The present invention relates to an optical head device that is used for reproducing optical recording media such as CDs and DVDs and a method of manufacturing an optical head device. More specifically, it relates to a mounting technology for mounting a frame-type laser photo emitter onto a base.

b) Description of the Related Art

An optical head device used for reproducing optical recording media such as CDs and DVDs has a laser photo emitter, an objective lens driving mechanism to which an objective lens is mounted for converging a laser light emitted by the laser photo emitter onto an optical recording medium and which is driven in the focusing direction and the tracking direction, a photo detector that detects returning light reflected from the optical recording medium, and an optical system component that guides the laser light between the laser photo emitter and the photo detector. These optical components are mounted on a base.

Conventionally, a laser photo emitter is of a can-type in which a semiconductor laser chip is stored in a cylindrical case. To mount such a can-type laser photo emitter onto the base, the laser photo emitter is first press-fitted into a photo emitter holder that has a circular hole, and then the photo emitter holder is adhered to the base.

Also a frame-type laser photo emitter has been proposed in which a laser photo emitter is mounted, without using a cylindrical case, to a base board called a lead frame that is shaped in an angular (box-type) outward form, to reduce size and cost. Such a frame-type laser photo emitter is directly mounted on a base and a flat spring is used to fix the frame-type laser photo emitter. (for example, see Tokkai H10-269601 Publication.

Problems Addressed by the Invention

However, such a frame-type laser photo emitter has a problem that it is difficult to press-fit the device into a photo emitter holder and then mount it onto a base. In other words, the cylindrical outward form of a can-type laser photo emitter makes it easier for the device to be press-fitted into a circular hole of a photo emitter holder; however, when a lead frame in an angular (box-type) outward form is press-fitted into a hole of the photo emitter holder with a rectangular cross-section, an excessive force is applied to the angular (box-type) lead frame, thus making the press-fitting difficult. Also, since an angular (box-type) lead frame in a frame-type laser photo emitter is formed of a thin plate, an excessive force during press-fitting may deform the frame. Such deformation degrades precision in mounting the laser photo emitter to the photo emitter holder.

In the photo emitter holder, the hole thereof having a rectangular cross-section that is for press-fitting a frame-type laser photo emitter is formed as a deep and narrow slit. It is difficult to manufacture a mold that can form such a slit. Therefore, a photo emitter holder cannot be manufactured easily using a mold.

Also, a frame-type laser photo emitter in which a base is formed of resin in order to reduce cost has a low ability in heat transmission, and therefore, heat generated thereby cannot be released. Further, since extended portions at both sides on a lead frame are pressed by a flat spring made of copper beryllium, heat generated by the frame-type laser photo emitter may be released, but not sufficiently because the mass of the flat spring is very small. For this reason, when the frame-type laser photo emitter is used for several hours, heat is stored in the frame-type laser photo emitter, which increases the temperature. This results in varying the wavelength of the emitted light and increasing the power consumed. Furthermore, since the frame-type laser photo emitter is used at high temperature for several hours, the life of the frame-type laser photo emitter is remarkably shortened. Moreover, when the optical system component is arranged in the vicinity of the frame-type laser photo emitter, it may be damaged; therefore, it needs to be arranged away from the frame-type laser photo emitter. This may result in making a larger optical head device.

### OBJECTS AND SUMMARY OF THE INVENTION

Considering the above problems, the primary object of the present invention is to provide an optical head device in which a frame-type laser photo emitter can be easily held by a photo emitter holder with a highly precise mounting and to provide a method of manufacturing such an optical head device.

Another object of the present invention is to provide an optical head device in which a frame-type laser photo emitter is kept from storing heat so that the property change thereof is prevented, durability thereof is improved and the device can be made small.

To achieve the above objectives, in an optical head device in which a frame-type laser photo emitter having a semiconductor laser chip mounted on a lead frame, which is molded of resin opening on the side where said chip is mounted, is mounted onto a base together with optical components, the present invention features the laser photo emitter which is mounted on the base via a photo emitter holder, the photo emitter holder which has mounting portions for mounting the laser photo emitter and a notch that is cut out in the direction orthogonal to an optical axis of a light emitted by the semiconductor laser chip for mounting the laser photo emitter onto the mounting portions, and the laser light emitter which is fixed to the notch by an adhesive.

In the present invention, it is preferred that the said adhesive is an UV cure type adhesive. With this, the adhesive can be immediately cured by UV illumination, shortening the time of the adhering process.

In the present invention, it is preferred that the laser photo emitter is mounted onto the mounting portions using the surface thereof which is on the back side of that on which the semiconductor laser chip is mounted, as a reference. With this configuration, a photo emitter holder can be formed of metal and mounted onto the mounting portions with the surface thereof beneath that on which the semiconductor laser chip is mounted, for example, so that heat generated by the semiconductor laser chip can be efficiently released to the photo emitter holder. Also, even when a laser photo emitter in which a semiconductor laser chip is exposed from a lead frame is used and the lead frame is mounted onto the mounting portions such that the semiconductor laser chip is exposed through the notch, the adhering process can be performed while the adhesive application condition is directly observed. This prevents the adhesive from coming into the lead frame, which may damage the semiconductor laser chip.

In the present invention, it is preferred that the photo emitter holder has a cylindrical wall, which the outer circumference thereof is formed cylindrically around the optical axis, and the notch is formed by cutting out a portion of the cylindrical wall. Particularly, the base is provided with a recess portion having an inner wall to which the cylindrical wall is press-fitted. With this, the positioning of the light-emitting point of the semiconductor laser chip with respect to the base can be easily performed.

It is preferred that a pressing member is provided for pressing the laser photo emitter onto the mounting portions. With this configuration, a frame-type laser photo emitter can be firmly fixed onto the mounting portions. Note that when manufacturing an optical head device in which a pressing member is used, it is preferred that the laser photo emitter is fixed to the photo emitter holder by curing the UV cure type adhesive while being pressed onto the mounting portions by the pressing member. With this configuration, the sai laser photo emitter is first firmly positioned on the mounting portions, and then can be fixed by an adhesive. Therefore, precise positioning of the said laser photo emitter with respect to the photo emitter holder can be obtained.

In addition, in an optical head device in which a frame-type laser photo emitter having a semiconductor laser chip mounted on a lead frame, which is molded of resin opening on the side where said chip is mounted so that the semiconductor laser chip is exposed to the outside, is mounted onto a base together with optical components, the present invention features the laser photo emitter which is mounted onto the base via a photo emitter holder formed of metal, the photo emitter holder which has mounting portions for mounting the lead frame and has a pressing member so that the lead frame is mounted onto the mounting portions while being pressed.

In the present invention, it is preferred that the pressing member is formed of a metallic thin plate. With this configuration, a large spring constant can be given, compared to one formed of resin of an equal thickness. Therefore, the pressing member can be formed thinner with the same spring constant, and so the device can be manufactured smaller by installing the pressing member in the device. Additionally, since metal has a higher ability in heat transmission compared to resin, the heat generated by the semiconductor laser chip can be released.

Further, in the present invention, it is preferred that the lead frame is mounted onto the mounting portions with the surface thereof which is on the back side of that on which the semiconductor laser chip is mounted, that is, the surface beneath that on which the semiconductor laser chip is mounted. With this configuration, the heat generated by the semiconductor can be efficiently released to the photo emitter holder.

Furthermore, in the present invention, the pressing member has a pair of bent portions that are bent in the same direction at both ends of a connecting portion, and the lead frame is pressed onto the mounting portions by engaging one of the bent portions with the laser photo emitter and the other with an engaging portion of the photo emitter holder. Particularly, it is preferred that the engaging portion is provided on the back side of the mounting portion on which the laser photo emitter is mounted and in a position at which the laser photo emitter can be held by a pair of the bent portions. With this configuration, the photo emitter holder is held between a pair of the bent portions that are bent in the same direction, so the lead frame can be mounted on the mounting portions while being pressed. Therefore, the pressing member can be fixed to the photo emitter holder without using a special fixing member. Note that it is preferred that the engaging portion is a plane parallel to the mounting portions.

In the present invention, it is preferred that the photo emitter holder has a notch that is cut out in the direction orthogonal to the optical axis of the light emitted by the semiconductor laser chip for mounting the lead frame onto the mounting portions, the lead frame is mounted onto the mounting portions such that the semiconductor laser chip is exposed through the notch, and at least a portion of the semiconductor laser chip exposed to the outside is covered by the pressing member. With this configuration, the lead frame can be easily mounted onto the mounting portions; even when a laser photo emitter is one in which the semiconductor laser chip is exposed from the frame and the lead frame is mounted in such a way that the semiconductor laser chip is exposed through the notch, since at least a portion of the semiconductor laser chip is covered by the pressing member, the semiconductor laser chip can be protected, particularly obtaining an effective protection from dust.

As described above, a frame-type laser photo emitter of the present invention is mounted onto a base via a light-emitting holder. Also, the photo emitter holder has a notch for mounting the laser photo emitter onto mounting portions. The notch is cut out in the direction orthogonal to the optical axis of the light emitted by the laser photo emitter. The laser photo emitter is fixed to the notch by an adhesive. For this reason, the adhesive can be easily but securely applied between the laser photo emitter and the photo emitter holder through the notch. Therefore, the laser photo emitter can be held by the photo emitter holder with an easy, highly precise mounting.

As described above, a frame-type laser photo emitter of the present invention is configured such that the lead frame thereof is mounted onto the mounting portions of the photo emitter holder while being pressed. Further, since the photo emitter holder is formed of metal, heat generated by the semiconductor laser chip can be released from the lead frame to the photo emitter holder through the mounting portions of the photo emitter holder, preventing heat storage in the laser photo emitter. Therefore, even when the laser photo emitter is of a frame-type, property change can be prevented, durability improved, and the device made small.

An optical head device to which the present invention is applied is described hereinafter referring to the drawings.

### BRIEF DESCRIPTION OF THE DRAWINGS

In the drawings:

FIG. 1 is a diagram showing an optical system of an optical head device to which the present invention is applied;

FIG. 2 is a perspective view of a frame-type laser photo emitter seen diagonally from the top;

FIGS. 3 (a) and (b) are respectively perspective views of a photo emitter holder seen from the back and diagonally from the top and seen from the front and diagonally from the bottom;

FIG. 4 (a) is a perspective view of the frame-type laser photo emitter mounted in the photo emitter holder, seen from the back and diagonally from the top, and FIG. 4 (b) is a perspective view that the frame-type laser photo emitter is mounted in the photo emitter holder and a pressing member is attached, seen from the back and diagonally from the top;

FIG. 5 (a) is a perspective view of the frame-type laser photo emitter mounted in a photo emitter holder, seen from the front and diagonally from the top, and FIG. 5 (b) is a perspective view that the frame-type laser photo emitter is mounted in the photo emitter holder and a pressing member is attached, seen from the front and diagonally from the top;

FIGS. 6 (a), (b), (c), and (d) are respectively a side view, bottom view, and front view of the pressing member and a perspective view of the pressing member seen diagonally from the top; and

FIG. 7 is a perspective view of the photo emitter holder, illustrated in FIG. 4 (b) and FIG. 5 (b), mounted to a base of the optical head device.

### DESCRIPTION OF THE PREFERRED EMBODIMENTS

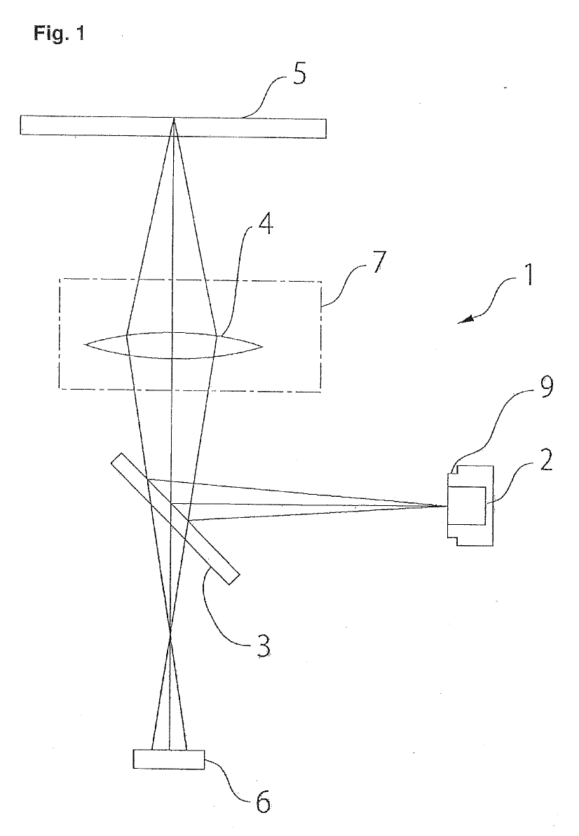

FIG. 1 is a diagram showing an example of an optical head device to which the present invention is applied.

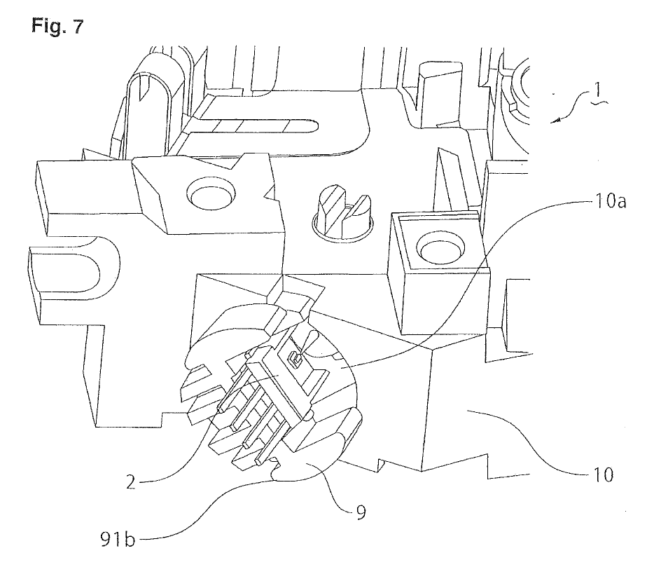

As illustrated in FIG. 1, an optical head device 1 is used for data recording and data reproducing with respect to an optical recording medium 5 such as CD or DVD; it has a laser photo emitter 2, a half mirror 3 that reflects a laser light emitted by the laser photo emitter 2 toward the optical recording medium 5, an objective lens 4 that converges the laser light reflected by the half mirror 3 onto the recording medium 5, and an optical detector 6 that detects the returning light that has been reflected from the optical recording medium 5 and passed through the objective lens 4 and the half mirror 3. These optical components are mounted onto a base 10 (see FIG. 7). Mounted on the base 10 is also an objective lens driving mechanism 7 for adjusting the positions of the objective lens 4 in the tracking direction and the focusing direction.

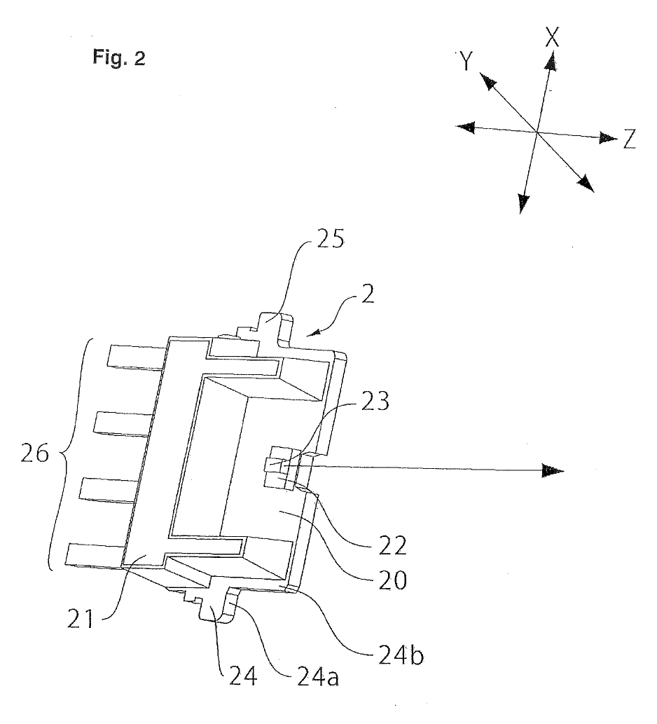

FIG. 2 is a perspective view of a frame-type laser photo emitter seen diagonally from the top.

As illustrated in FIG. 2, the laser photo emitter 2 used in this embodiment is of a frame-type in which a semiconductor laser chip 23 is stored in a lead frame 20 having an angular (box-type) outward form and (more specifically) mounted on the lead frame 20 via a sub mount 22. The lead frame 20 has extended portions 24, 25 at both sides thereof and four pin terminals 26 at the back edge. To obtain the protection of the semiconductor laser chip 23 and mechanical strength at the root portion of the pin terminals 26, the lead frame 20 has a frame 21 molded of resin expect the peripheral area of the mounting portions the semiconductor laser chip 23 is mounted. Note that the semiconductor laser chip 23 will generate laser light in the direction shown by the arrow in the figure.

The frame 21 molded of resin is cut out on the upper side in the emitting direction of the laser light and in the direction orthogonal to the emitting direction so that the semiconductor laser chip 23 is exposed to the outside. In other words, both sides (of the frame 20) orthogonal to the emitting direction of the laser light and the back are enclosed by resin. Note that, in the laser photo emitter 2 used in this embodiment, the width direction, the height direction and the optical axis direction of the laser light are defined as X, Y, and Z respectively; a reference surface for the semiconductor laser chip 23 in the Y direction at the light-emitting point is the surface of the lead frame 20 on the back side of the surface on which the semiconductor laser chip 23 is mounted.

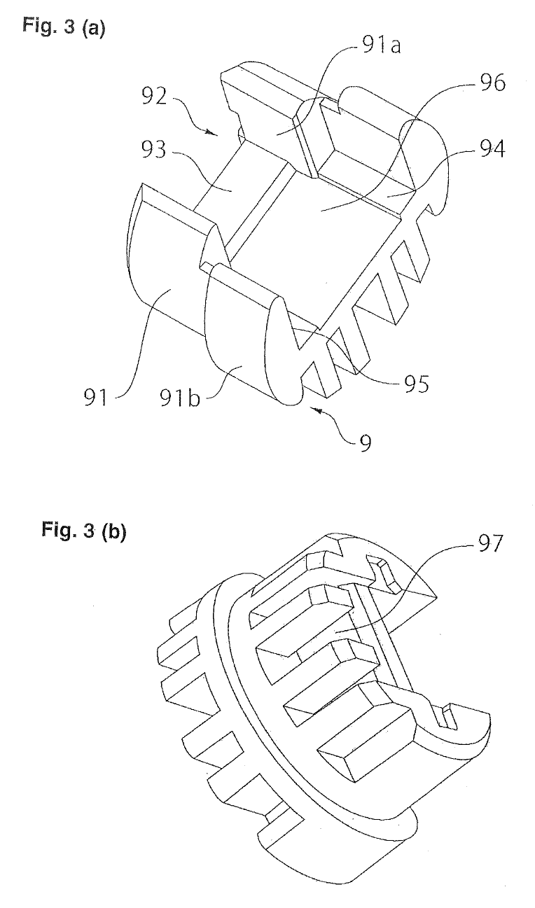

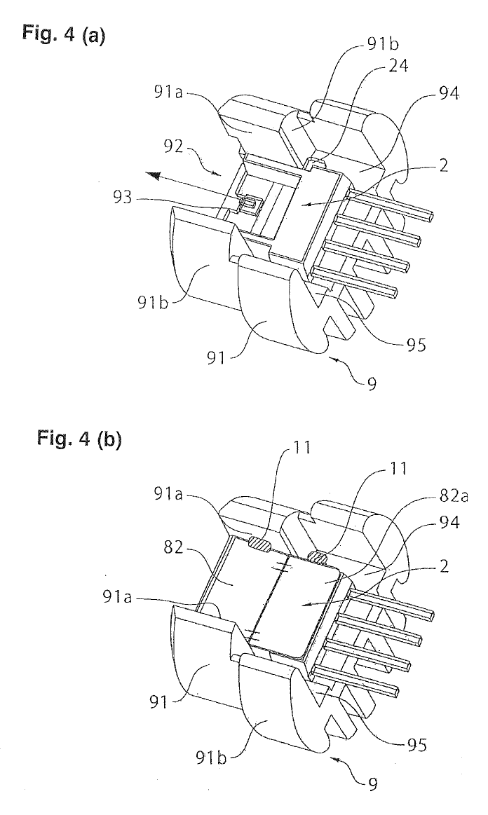

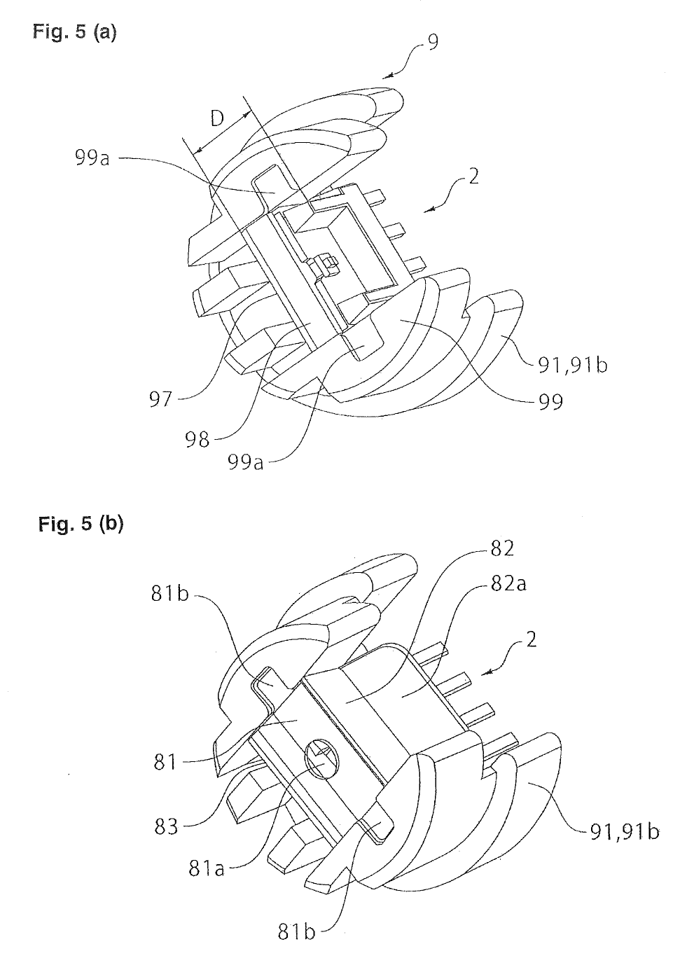

FIGS. 3 (a) and (b) are respectively perspective views of a photo emitter holder seen from the back and diagonally from the top and seen from the front and diagonally from the bottom. FIG. 4 (a) is a perspective view of the frame-type laser photo emitter mounted in the photo emitter holder, seen from the back and diagonally from the top, and FIG. 4 (b) is a perspective view of the frame-type laser photo emitter mounted in the photo emitter holder with the pressing member being attached, seen from the back and diagonally from the top. FIG. 5 (a) is a perspective view of the frame-type laser photo emitter mounted in the photo emitter holder, seen from the front and diagonally from the top, and FIG. 5 (b) is a perspective view of the frame-type laser photo emitter mounted in the photo emitter holder, with the pressing member being attached, seen from the front and diagonally from the top.

The frame-type laser photo emitter 2 is mounted onto a resin base 10 via a photo emitter holder 9 which is described hereinafter (see FIG. 7). The photo emitter holder 9 is formed of metal such as aluminum material. Note that the photo emitter holder 9 is not limited to one formed of aluminum material, but can be formed of other metal as long as the heat transmitting ability is sufficient.

As illustrated in FIG. 3, the photo emitter holder 9 has a notch 92 by cutting out a portion of a cylindrical wall 91 in the direction orthogonal to the optical axis of a laser light emitted by the semiconductor laser chip 23. At least a portion of the laser photo emitter 2 is to contact with the notch 92. In this embodiment, the photo emitter holder 9 has mounting portions 93, 94 and 95 onto which the laser photo emitter 2 is mounted. More specifically, the first mounting portion 93 and the second mounting portions 94, 95 are formed: onto the first mounting portion 93, the surface of the lead frame 20 in an angular (box-type) outward form, which is on the back side of the surface on which the semiconductor laser chip 23 is mounted, that is, the surface beneath that on which the semiconductor laser chip 23 is mounted; onto the second mounting portions 94 and 95, a pair of extended portions 24, 25 of the lead-frame 20 are respectively mounted. Note that the first mounting portion 93 and the second mounting portions 94 and 95 are formed on parallel planes of the same height.

The other portion of the photo emitter holder 9 is formed one step lower than the first mounting portion 93 and the second mounting portions 94 and 95 to be a step portion 96 with which the lead-frame 20 does not make contact. For this reason, the position of the laser photo emitter 2 in the Y direction is determined by these three surfaces, the first mounting portion 93 and the second mounting portions 94 and 95.

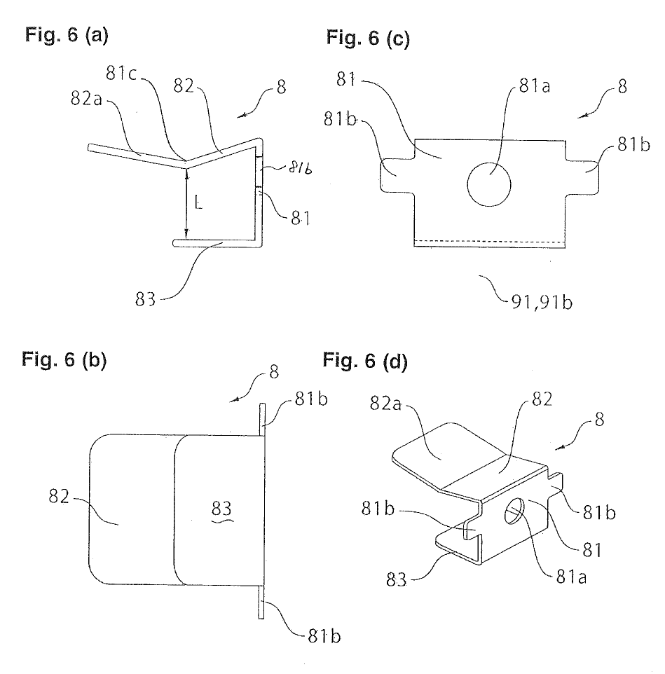

FIGS. 6 (a), (b), (c), and (d) are respectively a left view, bottom view, and front view of a pressing member and its perspective view seen diagonally from the top.

In this embodiment, a pressing member 8 illustrated in FIG. 6 is used for pressing the laser photo emitter 2 so that the lead frame 20 can be mounted onto the mounting portions 93, 94, and 95 while being pressed. The pressing member 8 is formed of metal; it may be formed of a thin plate of SUS material, for example. Note that the pressing member 8 is not necessarily limited to SUS material, but another metal may be used as long as the pressing force is suitable.

As illustrated in FIG. 6, the pressing member 8 of this embodiment has a pair of bent portions 82 and 83 that are bent at both ends of a connecting portion 81 in the same direction. A through-hole 81a is formed in the center of the connecting portion 81, and a pair of wing portions 81b and 81b are formed at both sides of the connecting portion 81. Note that, as illustrated in FIG. 4. (b) and FIG. 5 (b), the first bent portion 82 is engaged with the top surface of the frame 21 of the laser photo emitter 2, and the second bent portion 83 is engaged with an engaging surface 97 as an engaging portion of the photo emitter holder 9, which is under and parallel to the first mounting portion 93 (see FIG. 3 (b)).

Therefore, the lead frame 20 of the laser photo emitter 2 arranged between the first bent portion 82 and the second bent portion 83 can be mounted onto the mounting portions 93, 94, 95 while being pressed.

Note that, as illustrated in FIG. 6, the first bent portion 82 is configured such that the tip end portion of the first bent portion 82, from the middle point 81c to the tip end, is made as an inclined (bent) portion 82a that is inclined (bent) in the direction opposite the second bent portion 83 so that the first bent portion 82 and the second bent portion 83 can be smoothly engaged respectively with the top surface of the frame 21 of the laser photo emitter 2 and the engaging surface 97 while the laser photo emitter 2 is mounted onto the mounting portions 93, 94 and 95.

Also, the dimension, L, from the middle point 81c to the second bent portion 83 is set smaller than the dimension, D, from the top surface of the frame 21 to the engaging surface 97 (see FIG. 5); therefore, after the pressing member is attached, the lead frame 20 of the laser photo emitter 2 arranged between the first bent portion 82 and the second bent portion 83 can be mounted onto the mounting portions 93, 94 and 95 while being pressed.

Further, the connecting portion 81 is configured such that, with the pressing member 8 being installed in position, the area between the through-hole 81a and the second bent portion 83 make contact with the connecting surface 98 (see FIG. 5 (a)) which is on the front side in the laser light emitting direction and connects the first mounting portion 93 and the engaging surface 97 and also a pair of wing portions 81b, 81b make contact with the contact portions 99a, 99a of the front surface 99 of the cylindrical outer wall 91 on the front side in the laser light emitting direction. As illustrated in FIG. 5 (a), the contact portions 99a, 99a with which the wing portions 81b, 81b make contact are formed one step lower than other portions, and the contact portions 99a, 99a and the connecting surface 98 are formed in the same plane of the photo emitter holder 9, orthogonal to the direction of the optical axis of the laser light. For this reason, the three positions, which are a pair of wing portions 81b, 81b, the through-hole 81a, and the second bent portion 83, can be made to contact them simultaneously. Therefore, the light emitting point of the semiconductor laser chip 23 and the center of the through-hole 81a can be precisely aligned with each other, and thus the laser light emitted by the semiconductor laser chip 23 can pass through the through-hole 81a.

When the frame-type laser photo emitter 2 is held in this manner, the frame 21 molded of resin in the laser light-emitting direction is enclosed by the connecting portion 81 except the through-hole 81a, and the upper side of the frame 21, which is the space (the upper side) orthogonal to the emitting direction of the laser light, is enclosed by the first bent portion 82.

At that time, as illustrated in FIG. 4, the frame-type laser photo emitter 2 is configured such that the edge portion 24a of the extended portion 24 (see FIG. 2) is a referential surface for the semiconductor laser chip 23 in the Z direction at the light emitting point; the edge portion 24a hits the first referential surface 91b which is on the front side of the second mounting portion 94 and is orthogonal to the laser light optical axis direction; then by using the first referential surface 9 lb as a stop, the frame-type laser photo emitter 2 is positioned in the Z direction. Also, a perpendicular portion 24b (see FIG. 2) of the extended portion 24 which is on the front side of the edge portion 24a and orthogonal to the edge portion 24a is a referential surface for the semiconductor laser chip 23 in the X direction at the light-emitting point; the perpendicular portion 24b hits the inner wall 91a of the cylindrical outer wall 91 positioned at the side of the first mounting portion; then by using the referential surface as a stop, the laser photo emitter 2 is positioned in the X direction.

In the above manner, the frame-type laser photo emitter 2 is secured to the photo emitter holder 9 by the pressing member 8 and also fixed to the holder 9 by a UV adhesive which is applied to two locations on one side along the notch. Also, as illustrated in FIG. 4 (b), a pair of extended portions 24, 25 are adhered to the second mounting portions 94, 95 by a UV adhesive (UV cure type adhesive) 11. Furthermore, in this embodiment, the pressing member 8 is fixed to the photo emitter holder 9 by the UV adhesive 11. In other words, the first bent portion 82 is fixed to the inner wall 91a, 91a of the cylindrical outer wall 91 positioned at both sides of the first mounting portion 93 by the UV adhesive 11. The UV adhesive 11 application is performed after the laser photo emitter 2 is mounted onto the mounting portions 93, 94, 95 of the photo emitter holder 9 and the pressing member is attached; after the application, the UV adhesive 11 is cured by UV illumination.

When the photo emitter holder 9 holding the frame-type laser photo emitter 2 which is configured as above is engaged with the recess portion 10a formed in the base 10 of the optical head device 1 as illustrated in FIG. 7 and fixed by the adhesive, the laser photo emitter 2 can be mounted via the photo emitter holder 9. At that time, as for the photo emitter holder 9, the outer wall 9lb of the cylindrical outer wall 91 is press-fitted into the inner wall of the recess portion 10a. Therefore, the light-emitting point of the semiconductor laser chip 23 can be easily positioned with respect to the base 10.

In the optical head device 1 of this embodiment, the frame-type laser photo emitter 2 is configured such that the lead frame 20 thereof is mounted onto the mounting portion 93, 94, 95 of the photo emitter holder 9 while being pressed by the pressing member 8. Also, the photo emitter holder 9 has the notch 92 which is cut out in the direction orthogonal to the optical axis of the light emitted by the laser photo emitter 2 for mounting the laser photo emitter 2, and the laser photo emitter 2 is fixed to the notch 92 by the adhesive 11. For this reason, the adhesive can be easily and precisely applied to the laser photo emitter 2 and the photo emitter holder 9 through the notch 92. Therefore, the laser photo emitter 2 can be easily held by the photo emitter holder 9 with highly precise mounting.

In this embodiment, the adhesive is an UV cure-type adhesive, which can be instantly cured by illuminating UV rays. Thus, the operation time can be shortened.

Also, in this embodiment, the frame-type laser photo emitter 2 is mounted onto the mounting portions 93, 94, 95 using the surface which is on the back side of the surface on which the semiconductor laser chip 23 is mounted, as the referential surface. In particular, the photo emitter holder 9 is formed of aluminum and mounted onto the mounting portion 93 with the area of the surface beneath the semiconductor laser chip 23. Therefore, the heat generated by the semiconductor laser chip 23 can be efficiently released to the photo emitter holder 9.

Further, in this embodiment, the photo emitter holder 9 has the cylindrical outer wall 91 of which the outer circumference is formed cylindrically having the optical axis as a center, and the notch 92 is formed by cutting out a portion of the cylindrical outer wall 91. Therefore, the outer wall 91b of the cylindrical outer wall 91 is press-fitted into the inner wall of the recess portion 10a (of the base 10). Thus, the positioning of the light-emitting point of the semiconductor laser chip with respect to the base 10 can be easily performed.

Also, in this embodiment, (the optical head device 1) uses the pressing member 8 to secure the laser photo emitter 2 onto the mounting portions 93, 94, 95 with certainty. For manufacturing the optical head device 1, while the laser photo emitter 2 is being pressed by the pressing member 8 onto the mounting portions 93, 94, 95, the UV adhesive is cured to fix the laser photo emitter 2 into the photo emitter holder 9. In this manner, the laser photo emitter 2 is first positioned onto the mounting portions 93, 94, 95 and then adhered; therefore, the positional precision of the laser photo emitter 2 with respect to the photo emitter holder 9 can be obtained.

In the optical head device 1 of this embodiment, the frame-type laser photo emitter 2 is configured such that the lead frame 20 thereof is mounted onto the mounting portions 93, 94, 95 of the photo emitter holder 9 while being pressed by the pressing member 8. Also, since the photo emitter holder 9 is formed of metal, the heat generated by the semiconductor laser chip 23 is released from the lead frame 20 to the photo emitter holder 9 through the mounting portions 93, 94, 95, thus preventing the heat from being stored in the laser photo emitter 2. Therefore, even when the frame-type laser photo emitter 2 is used, property change is prevented, durability is improved and the device can be manufactured smaller.

In this embodiment, since the pressing member 8 is formed of a thin plate composed of an SUS material, a large spring constant can be used compared to one formed of resin of an equal thickness. Thus, using the same spring constant, the pressing member 8 can be made thinner. Therefore, when this pressing member 8 is installed in the device, the device can be manufactured smaller. In addition, since metal has higher ability in heat transmission than resin, the heat generated by the semiconductor laser chip 23 can be released more efficiently.

Further, in this embodiment, the lead frame 20 is mounted on the mounting portion 93 with the surface thereof which is on the back side of the surface on which the semiconductor laser chip 23 is mounted, that is, the surface beneath that on which the semiconductor laser chip 23 is mounted. Therefore, the heat generated by the semiconductor laser chip 23 can be efficiently released to the photo emitter holder 9.

Furthermore, the pressing member 8 has a pair of bent portions 82, 83 that are bent at both ends of the connecting portion 81 in the same direction; the bent portion 82 is engaged with the laser photo emitter 2 and the bent portion 83 is engaged with the engaging surface 97 of the photo emitter holder 9. In particular, the engaging surface 97 is a surface which is on the back side of the surface of the mounting portion 93 on which the laser photo emitter 2 is mounted and parallel to the mounting portion 93; it is formed at the position so that a pair of bent portions 82, 83 can hold the laser photo emitter 2. Therefore, since the photo emitter holder 9 is held between a pair of bent portions 82, 83, the lead frame 20 can be mounted onto the mounting portions 93, 94, 95 while being pressed. Thus, the pressing member 8 can be fixed to the photo emitter holder 9 without using a special fixture.

In this embodiment, the photo emitter holder 9 has the notch 92 that is cut out in the direction orthogonal to the optical axis of the light emitted by the semiconductor laser chip 23 for mounting the lead frame 20 onto the mounting portions 93, 94, 95; the lead frame 20 is mounted onto the mounting portions 93, 94, 95 such that the semiconductor laser chip 23 is exposed through the notch 92. Also, with the laser photo emitter 2 being held, the frame 21, molded of resin, in the laser light emitting direction is enclosed by the connecting portion 81 except the through-hole 81a, and also the upper portion thereof orthogonal to the laser light emitting direction is enclosed by the first bent portion 82. Therefore, the lead frame 20 can be easily mounted onto the mounting portions 93, 94, 95. Also, even when the frame 20 is mounted onto the mounting portions 93, 94, 95 so as to expose the semiconductor laser chip 23 through the notch 92, since the semiconductor laser chip 23 is covered by the pressing member 8, the semiconductor laser chip 23 can be protected, especially from dust.

In the above mentioned embodiment, the pressing member is formed of a thin plate composed of an SUS material; however, it is not limited to metal, but may be formed of resin.

Also, in the above mentioned embodiment, the adhesive is an UV (-cured) adhesive; however, it is not limited to UV adhesive, but an epoxy adhesive, etc. may be used.

Further, in the above mentioned embodiment, the pressing member 8 is provided for securing the laser photo emitter 2 onto the mounting portion 9; however, it may not be used. In other words, as long as the laser photo emitter 2 can be fixed to the photo emitter holder 9 by adhesive while it is being pressed, the lead frame 20 may be pressed onto the mounting portions 93, 94, 95 by pressing the laser photo emitter 2 by hand or using a jig.

Furthermore, in the above mentioned embodiment, the pressing member 8 is configured such that a pair of bent portions 82, 83 thereof are bent at both ends of the connecting portion 81 in the same direction; however, the pair of bent portions 82, 83 do not need to be bent in the same direction. In other words, as long as the lead frame 20 can be mounted onto the mounting portions 93, 94, 95 while being pressed onto them, the bent portions 82, 83 may be bent at both ends of the connecting portion 81 in different directions, or can be configured like an arc-like flat spring as shown in Patent Reference 1.

Moreover, in the above mentioned embodiment, the photo emitter holder 9 is cut out in the direction orthogonal to the optical axis of the light emitted by the semiconductor laser chip 23 to facilitate an easy mounting of the lead frame 20 onto the mounting portions 93, 94, 95; however, the photo emitter holder 9 may be cut out in any direction as long as the lead frame 20 can be mounted onto the mounting portions 93, 94, 95.

While the foregoing description and drawings represent the present invention, it will be obvious to those skilled in the art that various changes may be made therein without departing from the true spirit and scope of the present invention.

What is claimed is:

1. An optical head device comprising:
a frame-type laser photo emitter having a semiconductor laser chip mounted on a lead frame, said frame being molded of resin and opening on a side where said chip is mounted, said frame-type laser photo emitter being mounted onto a base together with optical components;
a photo emitter holder being provided for mounting said laser photo emitter on said base;
said photo emitter holder having mounting portions for mounting said laser photo emitter and a notch that is cut out in a direction orthogonal to an optical axis of light emitted by said semiconductor laser chip for mounting said laser photo emitter onto said mounting portions; and
said laser photo emitter being fixed to said notch by an adhesive.

2. The optical head device of claim 1 wherein said adhesive is an UV cure type adhesive.

3. The optical head device of claim 1 wherein said laser photo emitter is mounted on said mounting portions with a surface thereof which is on a back side of the surface on which said semiconductor laser chip is mounted, as a reference.

4. The optical head device of claim 1 wherein said photo emitter holder has a cylindrical wall, the outer circumference of which being formed cylindrically around said optical axis, and said notch being formed by cutting out a portion of said cylindrical wall.

5. The optical head device of claim 1 wherein said base is provided with a recess portion having an inner wall into which said cylindrical wall is press-fitted.

6. The optical head device of claim 1 wherein a pressing member is provided for pressing said laser photo emitter onto said mounting portions.

7. A method of manufacturing the optical head device of claim 6 wherein said laser photo emitter is adhered to said photo emitter holder by curing said UV cure type adhesive while being pressed onto said mounting portions by said pressing member.

8. An optical head device comprising:
a frame-type laser photo emitter having a semiconductor laser chip mounted on a lead frame, said frame being molded of resin and opening on a side where said chip is mounted such that said semiconductor laser chip is exposed to the outside, said frame-type laser photo emitter being mounted onto a base together with optical components';
a photo emitter holder formed of metal being provided for mounting said photo emitter on said base;
said photo emitter holder having mounting portions for mounting said lead frame and having a pressing member so that said lead frame is mounted onto said mounting portions while being pressed.

9. The optical head device of claim 8 wherein said pressing member is formed of a thin metallic plate.

10. The optical head device of claim 8 wherein said lead frame is mounted onto said mounting portions with a surface thereof which is on a back side of that on which said semiconductor laser chip is mounted, that is, the surface beneath that on which said semiconductor laser chip is mounted.

11. The optical head device of claim 8 wherein said pressing member has a pair of bent portions that are bent in the same direction at both ends of a connecting portion, and said lead frame is pressed onto said mounting portions by engaging one of said bent portions with said laser photo emitter and the other with an engaging portion of said photo emitter holder.

12. The optical head device of claim 11 wherein said engaging portion is provided on a back side of said mounting portion on which said laser photo emitter is mounted and in a position at which said laser photo emitter can be held by a pair of said bent portions.

13. The optical head device of claim 12 wherein said engaging portion is a plane parallel to said mounting portions.

14. The optical head device of claim 8 wherein said photo emitter holder has a notch that is cut out in a direction orthogonal to the optical axis of a light emitted by said semiconductor laser chip for mounting said lead frame onto said mounting portions, said lead frame being mounted onto said mounting portions such that said semiconductor laser chip is exposed from said notch, and at least a portion of said semiconductor laser chip exposed to the outside being covered by said pressing member.

15. The optical head device of claim 14 wherein, when the emitting direction of said emitted light is on a front side, said front side and an upper part of said laser chip are covered by said connecting portion and one of said bent portions.
